(19) United States
(12) Patent Application Publication
(10) Pub. No.: US 2024/0047899 A1
(43) Pub. Date: Feb. 8, 2024

(54) High-current plug connector for a battery management system

(71) Applicant: HARTING Electric Stiftung & Co. KG, Espelkamp (DE)

(72) Inventor: Sebastian GRIEPENSTROH, Lübbecke (DE)

(73) Assignee: HARTING Electric Stiftung & Co. KG, Espelkamp (DE)

(21) Appl. No.: 18/266,011

(22) PCT Filed: Nov. 29, 2021
(86) PCT No.: PCT/DE2021/100944

§ 371 Date: Jun. 8, 2023

(30) Foreign Application Priority Data
Dec. 10, 2020 (DE) 10 2020 132 962.8

(51) Int. Cl. H01R 4/20; H01R 13/53; H01R 13/629; H01M 50/543

(52) U.S. Cl. CPC H01R 4/20; H01R 13/53; H01R 13/62927; H01M 50/543

(57) ABSTRACT

A flush-mounted plug connector is suitable for use in a battery management system. A plug connector housing has an assembly flange for assembling the plug on a housing wall of a housing, e.g. of the battery management system. A plug contact is integrated into the plug connector housing. The plug contact has a plug-in axis, a plug-in region, and a cable connection region. The cable connection region can be connected to the battery management system via a connection cable which is designed as a high-current cable. The cable connection region is designed as a crimp connection such that the plug contact is a crimp contact which is held in the plug connector housing in a rotatable manner about the plug-in axis at least during the assembly process, and after being assembled, the integrated crimp contact can be disassembled again by means of a disassembly tool.

### CROSS-REFERENCE TO RELATED APPLICATION

This application is a national stage application, filed under 35 U.S.C. § 371, of International Patent Application No. PCT/DE2021/100944, filed on 29 Nov. 2021, which claims the benefit of German Patent Application No. 10 2020 132 962.8, filed 10 Dec. 2020.

### BACKGROUND

The disclosure relates to a high-current plug-in connector as a built-in plug-in connector for a battery management system. Furthermore, the disclosure relates to a system, comprising multiple batteries and multiple patch cables, a battery management system having a connection cable and a high-current plug-in connector. In addition, the disclosure relates to a method for mounting the high-current plug-in connector on a housing. The housing wall can be in particular the housing wall of a battery management system.

High-current plug-in connectors of this type are required in order to connect a battery management system on the plug-in side to a configurable pack (rechargeable battery pack) of multiple rechargeable batteries (accumulators) via at least one patch cable.

The prior art does disclose battery columns, rechargeable battery cabinets and rechargeable battery racks in which multiple rechargeable batteries are connected to one another in parallel and/or in series in order to adapt their current strength and output voltage to the respective requirements.

The publications DE 10 2015 105 482 B4 and US 2018/0358789 A1 describe the fundamental construction of such a switch cabinet or rack.

The publication EP 2 176 901 B1 shows a rechargeable battery for hand-held, electromechanical tools, having a plurality of rechargeable cells which are electrically fixedly connected to one another by means of multiple electric cell connectors.

The publication DE 10 2016 124 501 A1 discloses a battery management system for a configurable rechargeable battery pack.

The disadvantage is that during the construction of such systems, in view of the high current strengths, undesirably high transfer resistances occur between the connection cables of the battery management systems, said connection cables being customized on site as required, and the high-current plugs that can be connected thereto via a screw connection.

The German Patent and Trade Mark Office has searched the following prior art in the priority application relating to the present application: DE 10 2015 105 482 B4, DE 199 43 373 A1, DE 10 2016 124 501 A1, US 2004/0266260 A1, US 2018/0358789 A1, EP 2 176 901 B1 and CN 206 098 925 U.

### SUMMARY

An object of the disclosure is to reduce the transfer resistance between a connection cable, which is designed as a high-current cable, and a high-current plug-in connector for a battery management system.

The object is achieved by the subject matter of the independent claim(s).

A high-current plug-in connector is designed as a built-in plug-in connector and is provided for use in a battery management system. For this purpose, said high-current plug-in connector has a plug-in connector housing which is designed with a mounting flange for attaching on the plug-in side to a housing wall, in particular the housing wall of a housing of the battery management system.

Furthermore, the high-current plug-in connector has a plug-in contact that is inserted or is to be inserted into the plug-in connector housing and has a plug-in axis, a plug-in section and a cable connection section. Using the cable connection section, it can be connected to the battery management system and in particular is connected thereto, in other words in an electrically conductive manner, via a connection cable which is designed as a high-current cable.

The cable connection section is designed as a crimp connection so that the plug-in contact is a crimp contact. The crimp contact is retained in such a manner as to be able to rotate about its plug-in axis in the plug-in connector housing at least during the mounting procedure. Once mounted, the inserted crimp contact can be dismantled again by means of a dismantling tool. The plug-in contact is preferably a pin contact but the design as a socket contact or a hermaphrodite contact is also conceivable.

A battery system has multiple rechargeable batteries (accumulators) which each have at least two connections in the form of plug-in connectors and multiple patch cables via which the batteries are connected to one another at their connections in an electrically conductive manner in parallel and/or in series. Furthermore, the battery system has a battery management system having at least one high-current plug-in connector that is of the aforementioned type and is designed as a built-in plug. The batteries are connected to the battery management system in an electrically conductive manner via the at least one high-current plug-in connector.

The batteries can also be equipped with such a high-current plug.

Consequently, for example, at least one of the batteries can be connected at least at one of their high-current plug-in connectors via at least one patch cable to the high-current plug-in connector of the battery management system.

Advantageous embodiments are disclosed in the subordinate claims and the following description.

Advantageously, the high-current plug-in connector has a lower transfer resistance with regard to the connection cable than would be the case when using an alternative plug-in contact which is designed as a screw contact.

The advantage is that between the crimp contact and the connection cable only a single transfer resistance, namely the low transfer resistance, of the crimp connection is of significance. In contrast thereto, this is because when using the screw contact, two different transfer resistances are to be taken into consideration. A first transfer resistance occurs here due to the connection of the cable lug to the connection cable. For this purpose, the cable lug usually also has a crimp connection. However, a second electrical resistance that is in general even greater additionally occurs between the cable lug and the screw connection of the screw contact.

A further advantage of the disclosed connector is that said connection cable can be suitably customized with regard to its length directly during the configuration of the battery system in the rack, switch cabinet and/or shelf, etc.

Furthermore, a particular advantage is that the crimped plug-in connector contact is arranged in such a manner as to be able to rotate in the plug-in connector housing. As a result, the crimp contact can be appropriately oriented with respect to the plug-in connector housing without the connection cable becoming twisted. This is particularly advantageous because the cable thicknesses in the targeted high current range of for example up to 400 A can be in the order of magnitude of (depending on the possible maximum current strength) for example more than 20 mm², in particular more than 30 mm², especially preferably at least 50 mm², thus conceivably also up to 100 mm² and more, possible in the first place or at least considerably facilitated. Otherwise, the cable could offer considerable mechanical resistance to a possible twisting and thus hinder or even prevent the manual plug-in procedure.

In one advantageous embodiment, the plug-in connector housing can comprise an anti-rotation device for cooperating with the said screw contact. This is particularly advantageous because thereby the same plug-in connector housing can also be additionally used with the screw contact that as is known should not “simultaneously rotate” during the screwing procedure. The advantage is in particular that only a single type of plug-in connector housing need be designed, produced, warehoused and otherwise stored. Customers who like to use, for example, a screw contact for current strengths up to for example 200 A can use the same plug-in connector housing. In the case of current strengths up to for example 400 A, the same plug-in connector housing can be equipped as an alternative thereto with the crimp contact.

This has the advantage that the crimp contact does not cooperate with the anti-rotation device. Whereas the cable lug of the screw contact can be rotated into the desired position about the plug-in axis prior to being fixedly screwed to a nut or the like, the connection cable is to be regarded as non-releasably fixed to the crimp contact after the crimping procedure. However, in order for the connection cable to be suitably customized with regard to its length according to the respective conditions, for example the conditions of a particular rechargeable battery rack, it is necessary for the user to crimp the plug-in contact and manually insert it into the plug-in connector housing.

During the crimping procedure, however, it is not possible—or only with great effort—to foresee in which orientation the connecting cable must be attached to the plug-in connector for this purpose. Therefore, it is particularly advantageous that the crimp contact is retained in such a manner as to be able to rotate in the plug-in connector housing.

It is provided in a preferred embodiment that the plug-in connector housing for the crimp contact comprises a releasable anti-rotation device, for example a screwable anti-rotation device, by means of which the crimp contact that is inserted into the plug-in connector housing can be finally fixed in its desired position after being successfully rotated.

In advantageous embodiments, the anti-rotation device which is provided for cooperating with the alternative plug-in contact that is designed as a screw contact can be designed as at least one internal, in particular straight, shaping or as at least one connecting piece. The screw contact can then also comprise a counter-flattening or a groove which each cooperate with the flattening or the connecting piece. As a result, the screw contact can be retained in the plug-in connector housing in such a manner that said screw contact cannot rotate and can thus be screwed on the cable connection side.

In a preferred embodiment, the plug-in connector housing can have at least one latching arm for latching onto a latching collar of the crimp contact, wherein the at least one latching arm can also be removed again by means of the dismantling tool for dismantling the crimp contact from the latching collar so as to be unlatched.

Furthermore, in a further preferred embodiment, the plug-in connector can also have in addition to the said plug-in connector housing a cable fixing facility that comprises a separate second housing, namely a cable connection housing. This cable connection housing can also have in particular a flange. This flange is used to attach the cable connection housing on the cable connection side to the said housing wall.

This is particular advantageous because the plug-in contact can be initially crimped to the high-current cable and subsequently can be positioned in its proper position in the mounting housing, in other words without the cable having to be twisted.

Advantageously, the cable connection housing has a cable gland by means of which the crimp contact that is mounted in the plug-in connector housing can be fixed in its final position in the plug-in connector housing. In particular, the cable gland can have at its cable-connection side end a multiplicity of lamellae which are compressed by means of a union nut, which is to be screwed thereto, and fix the high-current cable and consequently the plug-in contact on its crimp section on the plug-in connector housing. It is preferred that the cable connection housing also has for this purpose a rubber clamp that assists the effect against torsional and tensile forces and additionally is effective in a sealing manner and a sealing element.

In a particularly preferred embodiment, the crimp contact is designed so as to transmit current strengths of more than 200 A (“amperes”), in particular more than 250 A, preferably more than 300 A and especially preferably more than 350 A, in other words for example up to 400 A and possibly even more.

One possible method for mounting the plug-in connector on the housing wall can be performed as follows:

Initially, the connection cable is suitably customized with regard to its length for the respective application. This can be done advantageously if the dimensions and requirements of the respective arrangement, in particular of the rechargeable battery rack, are known. A particular advantage is that the crimping procedure can be carried out together with the construction and/or mounting of the rechargeable battery rack, in other words there is no need to order pre-assembled cables, for example from the plug-in connector manufacturer, and transport them to the rack constructor/rack assembler. This simplifies the flexibility of the mounting procedure immensely.

The connection cable is subsequently, in particular on site, crimped to the crimp contact.

Subsequently, the crimp contact can be inserted on the cable connection side into the plug-in connector housing and latched therein and the plug-in connector housing is mounted, in particular screwed, on the plug-in side at a wall opening to the housing wall, wherein the sequence of these two steps is fundamentally also interchangeable, in other words the crimp contact can also be inserted into the plug-in connector housing that has been mounted previously.

It is particularly advantageous that the crimp contact is also retained at this point in time in such a manner as to be able to rotate in the plug-in connector housing and is not fixed therein, for example by means of polarization elements and/or the said anti-rotation device. This makes it possible in the first place, or at least considerably easier, to perform the mounting procedure with the attached high-current cable that has a cable cross section of, for example, more than 20 mm², in particular more than 30 mm², and especially preferably at least 50 mm², in other words conceivably also up to 100 mm² and more.

Subsequently, the said cable connection housing, through which the connection cable is routed, can be screwed on the cable connection side to the housing wall at the wall opening. The connection cable and the crimp contact that is fixedly crimped to it are then fixed in their final position by screwing the union nut to the cable gland.

In this manner, the crimp contact that is crimped on site can be initially flexibly mounted on the connection cable, which has been suitably customized with regard to its length, and then still fixed in its final position. It is of particular advantage that the same plug-in connector housing can also be used for a screw contact.

Furthermore, it is also possible in a particularly advantageous application to screw the cable connection housing directly to the plug-in connector housing in order to create a sleeve housing. In this manner, the individual components can be combined in numerous ways. In this manner, fewer individual products need to be produced and warehoused. The logistics are also accordingly simplified and the flexibility increases while storage costs are lower.

### BRIEF DESCRIPTION OF THE DRAWINGS

An exemplary embodiment of the invention is illustrated in the drawings and is further explained in the following. In the drawing:

FIGS. 1a, 1b show a plug-in connector housing having a screw contact;

FIGS. 2a, 2b show a plug-in connector housing having a crimp contact;

FIG. 3 shows the plug-in connector housing having the crimp contact and a cable connection housing.

### DETAILED DESCRIPTION

The figures include partially simplified, schematic representations. In part, identical reference signs are used for like but possibly not identical elements. Different views of like elements could be scaled differently.

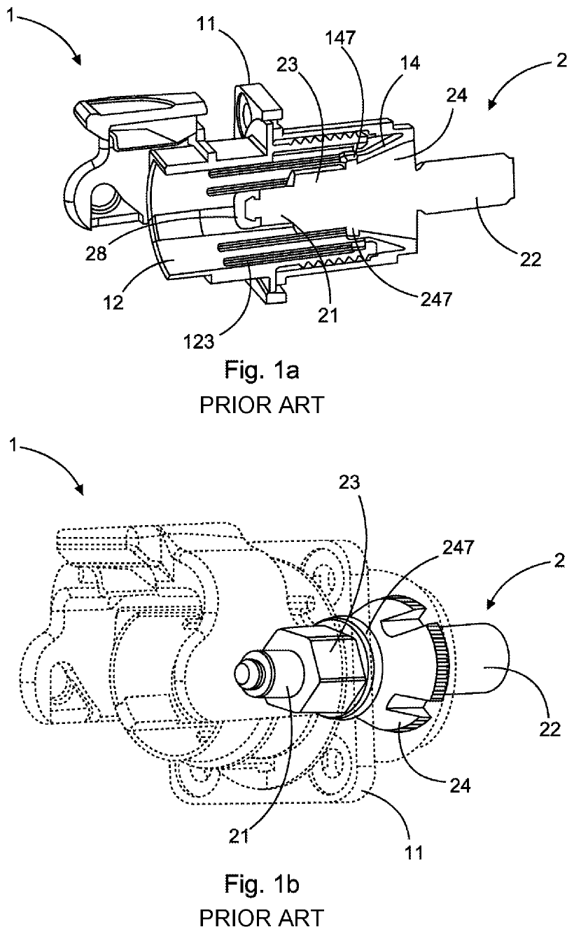

FIGS. 1a and 1b show a high-current plug-in connector having a plug-in connector housing 1 and a screw contact 2, as corresponds to the prior art of this type of high-current plug-in connectors.

The plug-in connector housing 1 has a mounting flange 11 and a contact chamber 12 that is substantially a hollow cylindrical shape. Connecting pieces 123 are formed on the inner side in the contact chamber 12. Furthermore, it has latching arms 14 that are formed on the cable connection side and extend in an oblique manner in the plug-in direction into the contact chamber and the ends of which each form a latching edge 147.

As is particularly apparent in FIG. 1a, the screw contact 2 has at its plug-in side end a plug-in section 21 with a touch guard 28 plugged thereon. It has on the opposite end a connection portion 22 that is designed as a screw connection. In-between, it has 2 adjacent to the plug-in section 21 a retaining portion 23 and a latching portion 24 that adjoins the retaining portion 23 with its latching collar 247. The latching portion 24 runs in a conical manner in the direction of the plug-in section 21. The retaining portion 23 has flattenings, not further illustrated, which actually provide it in the cross section, as is apparent in FIG. 1B, in the present example with a hexagonal cross section. The flattenings cooperate with the connecting pieces 123 of the plug-in connector housing 1 as an anti-rotation device. This prevents the screw contact 2 rotating about a plug-in axis so that it is possible in the installed state to screw it to its screw connection 22.

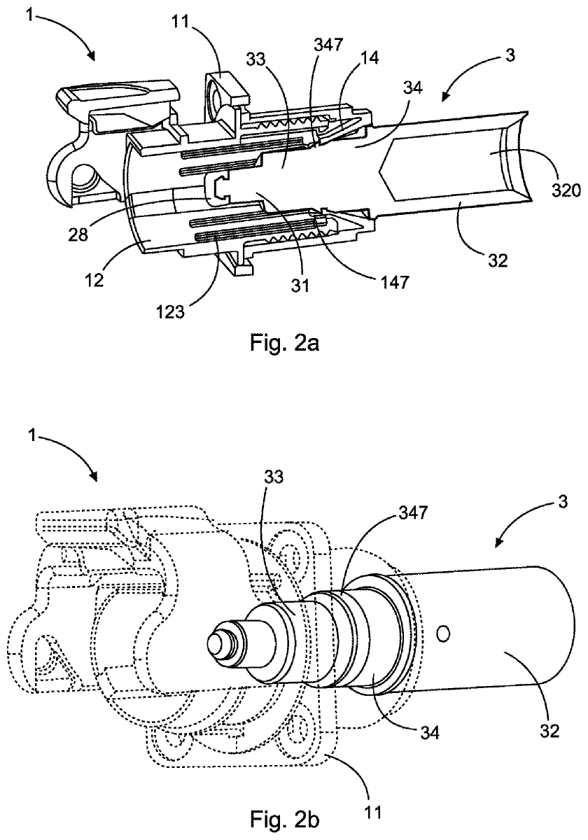

In contrast, FIGS. 2a and 2b show an arrangement that is formed from the plug-in connector housing 1 and a crimp contact 3.

The plug-in section 31 of the crimp contact 3 corresponds substantially to the plug-in section 21 of the screw contact 2.

Furthermore, this arrangement has the following differences with respect to the aforementioned arrangement:

The retaining portion 33 is designed in a cylindrical manner so that co-operation with the connecting pieces 123 is prevented and it can rotate about the plug-in axis.

The latching portion 34 that is arranged downstream of the latching collar 347 is also designed in a cylindrical manner, which renders it possible to insert the dismantling tool, not illustrated in the drawing.

The crimp contact 3 naturally has on the cable connection side a cable connection section that is designed as a crimp connection 32.

This arrangement renders it possible to customize the cable, in other words with regard to its length and crimping on site, without having to take into consideration the orientation of the high-current plug-in connector with respect to the connection cable regarding rotation about the plug-in axis. Finally, the crimp contact 3 can be inserted in any desired rotation into the plug-in connector housing 1 during installation of the high-current plug-in connector on a housing wall, in particular of a housing of a battery management system, and/or said crimp contact can be rotated in its inserted state as required. This is particularly important because as a result the high-current plug-in connector can be used without any problems with connection cables which have a cable thickness in the magnitude of for example 20 mm2 up to over 100 mm2, which are at least extremely inflexible with regard to twisting and/or do not allow such twisting at all.

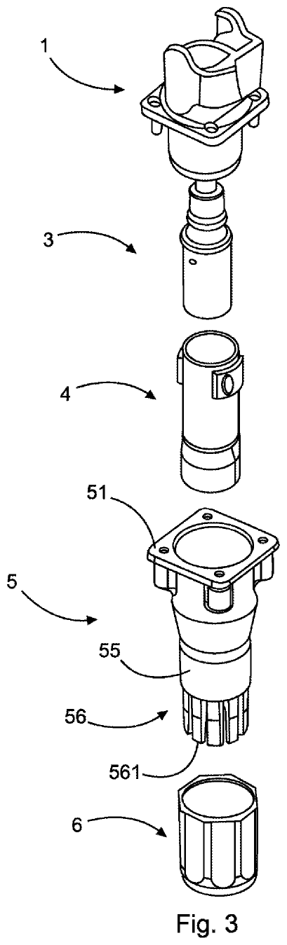

FIG. 3 shows an arrangement which in comparison to the preceding representation has been augmented by a cable fixing facility in an exploded view in which the components of this arrangement 1, 3, 4, 5, 6 are illustrated lying on the plug-in axis.

The cable fixing facility has a substantially hollow cylindrical rubber clamp 4 and a cable connection housing 5. This has a flange 51, a sealing element 55 and lamellae 561 which are a component of a clamping facility 56 of a cable gland. Furthermore, the cable gland comprises a union nut 6 by means of which the connection cable can be guided and with its help can be fixed on the cable connection housing 5.

As the drawing suggests, these components 1, 3, 4, 5, 6 can be directly combined in one embodiment in that the mounting flange 11 of the plug-in connector housing 1 is screwed directly to the flange 51 of this cable connection housing 5. As a result, in this embodiment with these components, a moveable high-current plug-in connector is mounted with a sleeve housing.

In a further embodiment, the same components can also form a built-in plug. For this purpose, the plug-in connector housing 1 is used as a mounting housing and is screwed on the plug-in side—in other words from outside—at a wall opening to a housing wall of the device housing, in the present case a housing of a battery management system. The crimped contact 3 that is crimped to the connection cable, not illustrated in the drawing, can already be guided through the wall opening and inserted into the mounting housing 1. Alternatively thereto, it can also be inserted on the cable connection side into the mounting housing 1 that is already mounted on the housing wall. The crimp contact 3 is retained so as to be able to rotate about the plug-in axis in the mounting housing 1. The crimp contact is already efficiently fixed in its final position by attaching the rubber clamp 4 and the cable connection housing 5 to the cable connection section 32 and by screwing the cable connection housing 5 to its flange 51 on the cable connection side of the housing wall. The connection cable is finally fixed to the cable connection housing 5 and consequently also the crimp contact 3 is finally fixed in the mounting housing 1 by screwing the union nut 6 onto the clamping facility 56.

Even if the figures show different aspects or features of the invention in each case in combination, it is apparent to the person skilled in the art—unless otherwise stated—that the illustrated and discussed combinations are not the only possibilities. In particular, mutually corresponding units or feature complexes from different exemplary embodiments can be interchanged with one another.

### LIST OF REFERENCE SIGNS

1 Plug-in connector housing/mounting housing
11 Mounting flange
12 Contact chamber
123 Connecting pieces
14 Latching arm
147 Latching edge
2 Screw contact
21 Plug-in section
22 Cable connection section (screw connection)
23 Retaining portion
24 Latching portion
247 Latching collar
28 Touch guard
3 Crimp contact
31 Plug-in section
32 Cable connection section (crimp connection)
33 Retaining portion
34 Latching portion
347 Latching collar
4 Rubber clamp
5 Cable connection housing
51 Flange
55 Sealing element
56 Clamping facility
561 Lamellae
6 Union nut

1.-13. (canceled)

14. A high-current plug-in connector that is designed as a built-in plug-in connector and is suitable for use in a battery management system, comprising:
a plug-in connector housing (1), the plug-in connector housing (1) having
a mounting flange (11) for attaching the plug-in connector housing (1) on a plug-in side to a housing wall; and
a crimp contact (3) that is inserted into the plug-in connector housing (1) and has
a plug-in axis,
a plug-in section (31), and
a cable connection section (32),
wherein the high-current plug-in connector (1) with its cable connection section (32) can be connected to the battery management system via a high-current connection cable,
wherein the crimp contact (3) is retained in such a manner as to be able to rotate about its plug-in axis in the plug-in connector housing (1) at least during a mounting procedure, and
wherein the crimp contact (3) can be dismantled by a dismantling tool after the crimp contact (3) has been inserted.

15. The high-current plug-in connector as claimed in claim 14,
wherein the plug-in connector housing (1) comprises an anti-rotation device (123) for cooperating with an alternative plug-in contact which is designed as a screw contact (2), and
wherein the crimp contact (3) does not co-operate with the anti-rotation device (123).

16. The high-current plug-in connector as claimed in claim 15,
wherein the anti-rotation device comprises at least one internal straight shaping or at least one connecting piece (123).

17. The high-current plug-in connector as claimed in claim 15,
wherein the crimp contact (3) comprises a cylindrical retaining portion (33) without flattenings or indentations between its plug-in section (31) and its cable connection section (2).

18. The high-current plug-in connector as claimed in claim 14,
wherein the plug-in connector housing (1) has at least one latching arm (14) for latching onto a latching collar (347) of the crimp contact (1), and
wherein the at least one latching arm (14) can be removed by the dismantling tool for dismantling the crimp contact (1) from the latching collar (347).

19. The high-current plug-in connector as claimed in claim 14, further comprising
a separate cable connection housing (5), which has a flange (51) for attaching on a cable connection side to the housing wall.

20. The high-current plug-in connector as claimed in claim 19,
wherein the cable connection housing (5) comprises a cable gland by which the crimp contact (3) that is mounted in the plug-in connector housing (1) can be fixed in a final position in the plug-in connector housing (1).

21. The high-current plug-in connector as claimed in claim 20, further comprising
a rubber clamp (4) for additionally fixing the crimp contact (3) in the plug-in connector housing (1).

22. The high-current plug-in connector as claimed in claim 14,
wherein the crimp contact (3) is designed so as to transmit an electric current of more than 300 A.

23. A battery system, comprising:
multiple rechargeable batteries and multiple patch cables via which the batteries are connected to one another in an electrically conductive manner in parallel and/or in series; and
a battery management system that is equipped with at least one high-current plug-in connector as claimed in claim 14,
wherein the batteries are connected via the at least one high-current plug-in connector to the battery management system and in each case at least one of the patch cables.

24. The battery system as claimed in claim 23,
wherein the batteries are also equipped with the high-current plug-in connector according to claim 14.

25. A method for mounting the high-current plug-in connector as claimed in claim 20 to a housing wall, comprising:
A. suitably customizing the connection cable with regard to its length for a respective application;
B. crimping the connection cable onto the crimp contact (3);
C. inserting the crimp contact (3) on a cable connection side into the plug-in connector housing (1) and latching therein and screwing the plug-in connector housing (1) the plug-in side at a wall opening to the housing wall;
D. screwing the cable connection housing (5) on the cable connection side at the wall opening to the housing wall and in so doing encompassing the connection cable; and
E. fixing the connection cable and the crimp contact (3) that is fixedly crimped thereto in their final position by screwing a union nut (6) to the cable connection housing (5).

26. The method as claimed in claim 25, wherein in method step D so as to additionally fix the crimp contact (3) a rubber clamp (4) is arranged between the crimp contact (3) and the plug-in connector housing (1).
